(19) United States
(12) Patent Application Publication
(10) Pub. No.: US 2015/0081950 A1
(43) Pub. Date: Mar. 19, 2015

(54) MEMORY SYSTEM AND INFORMATION PROCESSING DEVICE

(71) Applicant: KABUSHIKI KAISHA TOSHIBA, Tokyo (JP)

(72) Inventor: Hitoshi NEZU, Kanagawa (JP)

(73) Assignee: KABUSHIKI KAISHA TOSHIBA, Tokyo (JP)

(21) Appl. No.: 14/194,600

(22) Filed: Feb. 28, 2014

(30) Foreign Application Priority Data
Sep. 13, 2013 (JP) 2013-191142

(51) Int. Cl. G06F 12/02

(52) U.S. Cl. CPC G06F 12/0246; G06F 2212/7201
USPC 711/103

(57) ABSTRACT

A memory system includes a non-volatile memory which is configured in units of erasable blocks each having a first size and units of pages each having a second size within each block, a page size identification information storage unit configured to store a third size that is smaller than the second size, and a control unit configured to convert a first address designated in a command received by the memory system into a second address. The first address specifies a page number of pages having the third size and the second address specifies a page number of pages having the second size.

### CROSS-REFERENCE TO RELATED APPLICATION

This application is based upon and claims the benefit of priority from Japanese Patent Application No. 2013-191142, filed Sep. 13, 2013, the entire contents of which are incorporated herein by reference.

### FIELD

Embodiments described herein relate generally to a memory system and an information processing device including a non-volatile semiconductor memory.

### BACKGROUND

A flash memory system which is incorporated in a smart device such as a smart phone, a tablet PC, or the like, as a host system, includes a controller with a simple control function, and flash memory as a non-volatile semiconductor memory. The flash memory includes a plurality of blocks as erasable units, and each block is configured with a plurality of pages.

A host system obtains page size identification information which denotes a page size of a flash memory at the time of booting from the memory system side, and determines a page size of the flash memory based on the obtained page size identification information.

However, when a page size which can be identified by a boot program of a host system, and a page size which is obtained from a flash memory are different from each other, there is a case in which the host system cannot be started. As page size of a flash memory becomes larger along with progress in technology due to a change in semiconductor design rules, it is desired to provide a memory system in which a host system can be started even when an actual page size of a flash memory is larger than a page size which can be identified by a boot program of a host system.

### DESCRIPTION OF THE DRAWINGS

FIG. 1 is a diagram which illustrates a configuration example of a memory system according to a first embodiment.

FIG. 2 is a diagram which illustrates examples of page size identification information.

FIG. 3 is a diagram which illustrates order of resetting of the page size identification information.

FIG. 4 is a diagram which illustrates another example of the page size identification information.

FIG. 5 is a flowchart which illustrates operation order when starting a host system.

FIG. 6 is a diagram which illustrates address conversion information between an address on the host system side and an address on the memory system side.

FIG. 7 is a diagram showing a storage location of a device driver in a NAND.

FIG. 8 is a conceptual diagram which illustrates readout processing of the memory system.

FIG. 9 is a processing diagram which illustrates readout processing of the memory system.

FIG. 10 is a time chart which illustrates readout processing of the memory system.

FIG. 11 is a time chart which illustrates write processing of the memory system.

FIG. 12 is a conceptual diagram which illustrates write processing of the memory system.

FIG. 13 is a time chart which illustrates another example of the write processing of the memory system.

FIG. 14 is a time chart which illustrates still another example of the write processing of the memory system.

FIG. 15 is a conceptual diagram which illustrates another example of the write processing of the memory system.

FIG. 16 is a flowchart which illustrates order of write processing of the memory system.

### DETAILED DESCRIPTION

According to an aspect of exemplary embodiments, it is desirable to provide a memory system and an information processing device which can start a host system even when a page size of a non-volatile semiconductor memory which is included in the memory system, and a page size which can be identified by the host system are different from each other.

In general, according to one embodiment, a memory system includes a non-volatile memory, a page size identification information storage unit, and a control unit. The non-volatile memory is configured in units of erasable blocks each having a first size and units of pages each having a second size within each block. The page size identification information storage unit is configured to store a third size that is smaller than the second size. The control unit is configured to convert a first address designated in a command received through the interface unit into a second address. The first address specifies a page number of pages having the third size and the second address specifies a page number of pages having the second size.

Hereinafter, a memory system and an information processing device according to embodiments will be described in detail with reference to accompanying drawings. In addition, the exemplary embodiment is not limited by these embodiments.

### First Embodiment

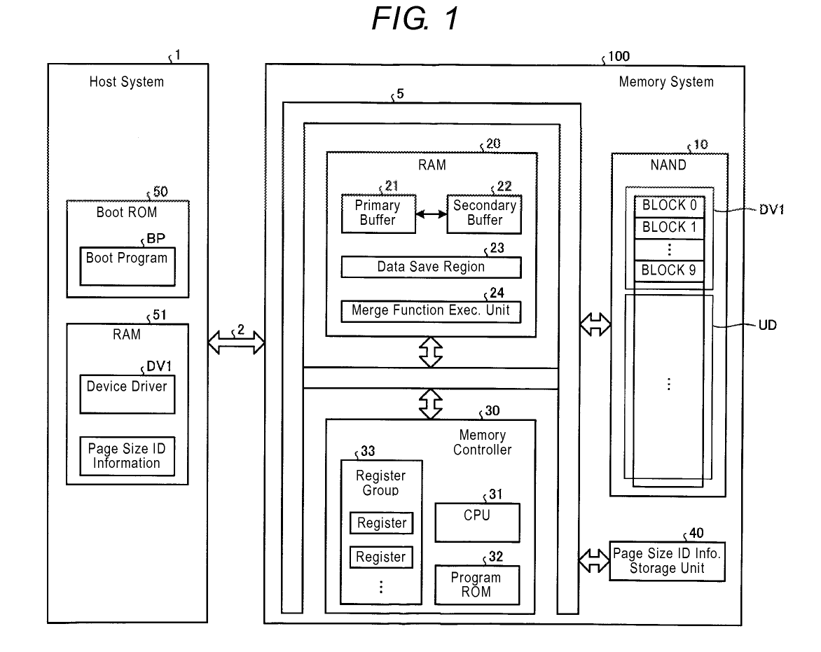

FIG. 1 illustrates a configuration example of a memory system 100 according to a first embodiment. The memory system 100 is connected to a host system 1 (hereinafter, referred to as host) through an interface 2, and functions as an external storage device of the host 1. The host 1 is a smart device such as a smart phone, or a tablet PC, for example.

The memory system 100 includes a NAND-type flash memory 10 (hereinafter, referred to as NAND) as a non-volatile memory, a memory controller 30, a RAM 20 as a volatile semiconductor memory, a page size identification information storage unit 40, and an I/O bus 5.

The NAND 10 stores a device driver DV1 which drives the memory system 100, user data UD which is transmitted from the host 1, or the like. The device driver DV1 is used in the host 1. An operating system or application software of the host 1 executes write and readout of data with the memory system 100 through the device driver DV1.

The NAND 10 is configured by including a plurality of blocks. A block represents a unit of erasable data. The block is configured with a plurality of pages. According to the embodiment, the device driver DV1 is stored in blocks 0 to 9, and the user data UD is stored in blocks beginning with block 10. Here, according to the embodiment, the actual page size of each page of the NAND 10 is set to 8 KB, and one block is set so as to be configured with 256 pages. That is, one block of the NAND 10 is set to 2 MB. The page size of the NAND 10 may, however, be 16 KB, or 32 KB, or some other size.

The memory controller 30 includes a CPU 31 as a processor which controls the memory system 100, a program ROM 32 in which firmware as a control managing program which is executed on the CPU 31 is stored, and a peripheral register group 33 which includes a plurality of registers in which a command transmitted from the host 1, an answer from the memory system 100, and the like, are set.

The RAM 20 includes a primary buffer 21 and a secondary buffer 22 as buffer regions for temporarily storing data which is transmitted between the host 1 and the NAND 10, data save region 23, and a region in which a control program as firmware which is stored in the program ROM 32 is executed. In FIG. 1, a merge function execution unit 24 which functions as a composition processing unit that executes composition processing of data according to a merge program, is illustrated. As will be described later, the merge program includes a function of writing data from the host 1 in the NAND 10 by merging a plurality of the data items, and an address conversion function of converting an address for merging in which a physical address designated by the host 1 is converted into a physical address of the NAND 10.

The page size identification information storage unit stores page size identification information PI which identifies a page size in a storage region in which the device driver DV1 of the NAND 10 is stored. The page size identification information storage unit 40 is configured with a rewritable non-volatile memory such as an Electrically Erasable Programmable Read-Only Memory (EEPROM), a Serial Peripheral Interface (SPI) flash memory, or the like. Alternatively, the page size identification information PI which is stored in the page size identification information storage unit 40 may be stored in the NAND 10. The page size identification information PI will be described in detail later.

The host 1 includes a boot ROM 50 in which a boot program BP of the host 1 is stored, and a RAM 51 as a non-volatile memory. The CPU, an operating system (OS), or the like, in the host 1 is not shown for convenience. In the RAM 51, the device driver DV1 which is kept in the NAND 10 is read out from the memory system 100, and is stored. In addition, when resetting the page size identification information PI, the page size identification information which is kept in the page size identification information storage unit 40 is read out from the memory system 100, and is stored in the RAM 51.

Here, the boot program BP which is stored in the boot ROM 50 is assumed to recognize that a non-volatile semiconductor memory of the memory system which is connected thereto has a page size of 2 KB, for example. As described above, the actual page size of the NAND 10 is 8 KB, and is larger than a page size which is recognized by the boot program. That is, a page size which is recognized by the boot program BP is a natural number 1/n (n is natural number which is equal to or greater than 2) of the actual page size of the NAND 10. Here, n is 4.

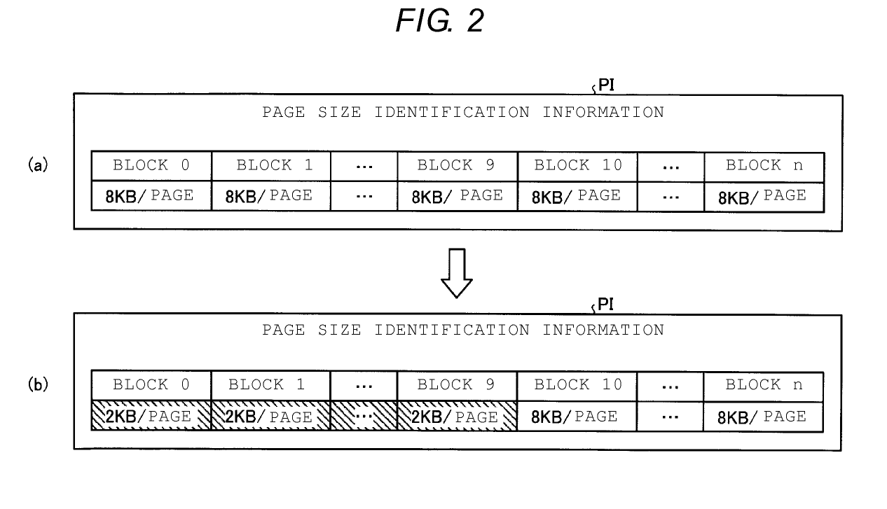

FIG. 2 illustrates examples of the page size identification information PI which is stored in the page size identification information storage unit 40. The page size identification information PI in FIG. 2 has a format in which a page size can be arbitrarily set per block. FIG. 2(a) illustrates a set state of the page size identification information PI in an initial state in which the memory system 100 is incorporated in the host 1. In FIG. 2(a), the page size of the page size identification information PI is set to 8 KB with respect to all of the blocks 0 to n, and matches the actual page size of the NAND 10.

The page size identification information PI which is stored in the page size identification information storage unit is rewritable from the outside. For this reason, a manufacturer of the host 1, or a manufacturer of a chip set can cause the blocks 0 to 9 as a storage region of the NAND 10 to which the boot program BP accesses to match a page size which is recognized by the boot program BP by rewriting the page size identification information PI which is stored in the page size identification information storage unit 40.

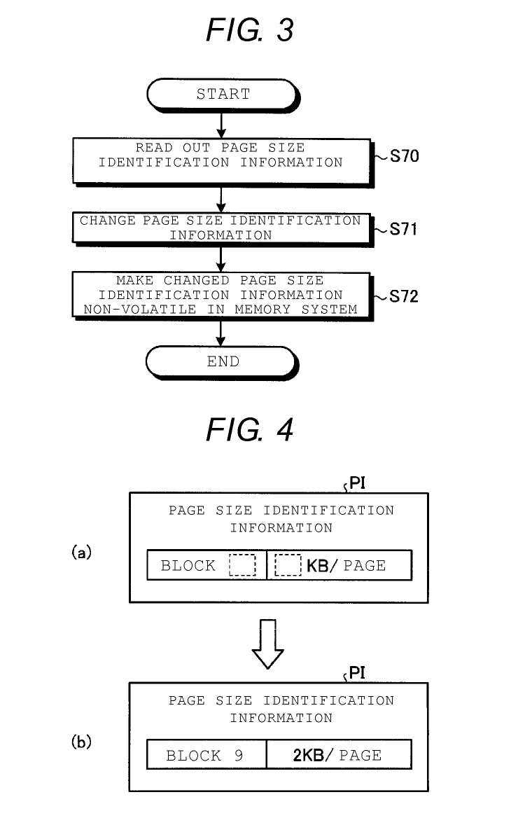

FIG. 3 illustrates rewriting order of the page size identification information PI which is stored in the page size identification information storage unit 40 from the host 1 side. First, a manufacturer of the host 1, or a manufacturer of the chip set performs command setting in a register of the peripheral register group 33 of the memory system 100, and commands readout of the page size identification information PI which is stored in the page size identification information storage unit 40 of the memory system 100. Due to the command setting in a register of the peripheral register group 33, the firmware which works on the CPU 31 reads out the page size identification information PI which is illustrated in FIG. 2(a), for example, from the page size identification information storage unit 40, and transmits the read out page size identification information PI to the host 1 through the secondary buffer 22, the primary buffer 21, the I/O bus 5, and the interface 2 (step S70).

The page size identification information PI which is transmitted from the memory system 100 is stored in the RAM 51. The manufacturer of the host 1, or the manufacturer of the chip set changes the page size identification information PI on the RAM 51 as illustrated in FIG. 2(b), for example (step S71).

FIG. 2(b) illustrates the page size identification information PI which is changed by the manufacturer of the host 1, the manufacturer of the chip set, or the like. In FIG. 2(b), the blocks 0 to 9 of the NAND 10 in which the device driver DV1 are stored are changed to a page size of 2 KB which can be recognized by the boot program BP. Due to this, the boot program BP can recognize the memory system 100 as a memory device which satisfies boot conditions which are described in the boot program BP when starting the host 1.

The page size identification information PI which is changed on the host 1 side is set along with a command in the register of the peripheral register group 33 of the memory system 100 by the host 1. Due to the command setting in the peripheral register group 33, the firmware which works on the CPU 31 writes the page size identification information PI which is set in the register of the peripheral register group 33 in the page size identification information storage unit 40, and makes the information non-volatile (step S72). In this manner, resetting of the page size identification information PI is performed.

FIG. 4 illustrates another format example of the page size identification information PI which is stored in the page size identification information storage unit 40. In the format, it is possible to set a page size from a top block to an arbitrary block. FIG. 4(a) illustrates a set state of the page size identification information PI in an initial state in which the memory system 100 is incorporated in the host 1. In FIG. 4(a), a portion to which a number of the block number is input, and a portion to which a page size is input become blanks in the page size identification information PI. FIG. 4(b) illustrates the page size identification information PI which is changed by the manufacturer of the host 1, the manufacturer of the chip set, or the like. In FIG. 4(b), the block 9 is set so as to have a page size of 2 KB, and due to this, both of the boot program BP and the memory system 100 recognize that the blocks 0 to 9 of the NAND 10 in which the device driver DV1 is stored have a page size of 2 KB which is recognizable by the boot program BP.

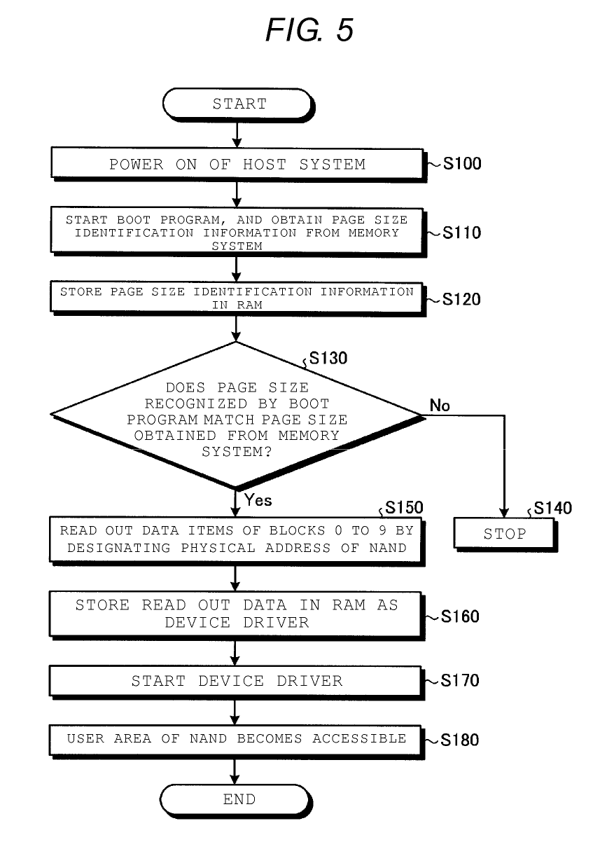

Subsequently, operating order of the host 1 in which the memory system 100 is incorporated at the time of starting in a normal operation will be described with reference to FIG. 5. At first, a power source of the memory system 100 is turned on when a power source of the host system 1 as shown in step S100 in FIG. 5 is turned on in the normal operation, and is started according to order of steps S110 to S170. However, in the normal operation of the host 1, the page size identification information PI which is stored in the page size identification information storage unit 40 of the memory system 100 is reset to a page size which is recognizable by the boot program BP, as illustrated in FIG. 2(b), or in FIG. 4(b).

When the host 1 is started (step S100), the boot program BP which is stored in the boot ROM 50 is started. The boot program BP requests readout of the page size identification information PI which is stored in the page size identification information storage unit 40 of the memory system 100. The CPU 31 recognizes the readout request from the host 1 due to the command setting in the register of the peripheral register group 33 by the boot program BP. The CPU 31 reads out the page size identification information PI which is illustrated in FIG. 2(b), for example, from the page size identification information storage unit 40, and transmits the read out page size identification information PI to the host 1 through the secondary buffer 22, the primary buffer 21, the I/O bus 5, and the interface 2 (step S110). The boot program BP stores the page size identification information PI which is transmitted from the memory system 100 in the RAM 51 (step S120).

The boot program BP compares a page size of the NAND 10 which is recognized by the boot program BP itself to the page size which is registered in the page size identification information PI which is obtained from the memory system 100 (step S130), and when both sizes do not match each other, processes thereafter are stopped (step S140). For example, as illustrated in FIG. 2(a), when all of the pages are set to 8 KB as the page size identification information PI, the boot program BP cannot recognize the memory system 100 as a memory device which satisfies the boot conditions which are described in the boot program BP, and the process is stopped at this point.

On the other hand, when both sizes match each other according to the determination in step S130, the boot program BP requests data readout of the blocks 0 to 9 of the NAND 10 of the memory system 100. When the boot program BP sets a readout command, and physical addresses of the blocks 0 to 9, in the register of the peripheral register group 33, the request for readout from the memory system 100 is executed.

The CPU 31 reads out data from the blocks 0 to 9 of the NAND 10, and transmits the read out data to the host 1 through the secondary buffer 22, the primary buffer 21, the I/O bus 5, and the interface 2 (step S150). The boot program BP stores the data which is transmitted from the memory system 100, in the RAM 51 as the device driver DV1 (step S160). Subsequently, the boot program BP starts the device driver DV1 by setting a program counter of the host 1 in the device driver DV1 (step S170). When the device driver DV1 is started, a state is reached in which it is possible to access to the user storage region UD of the NAND 10 from the OS, or the application of the host 1 (step S180). The device driver DV1 is read out when the memory system 100 and the host 1 are started, and the user data which is stored in the user storage region UD is read out after starting the memory system 100.

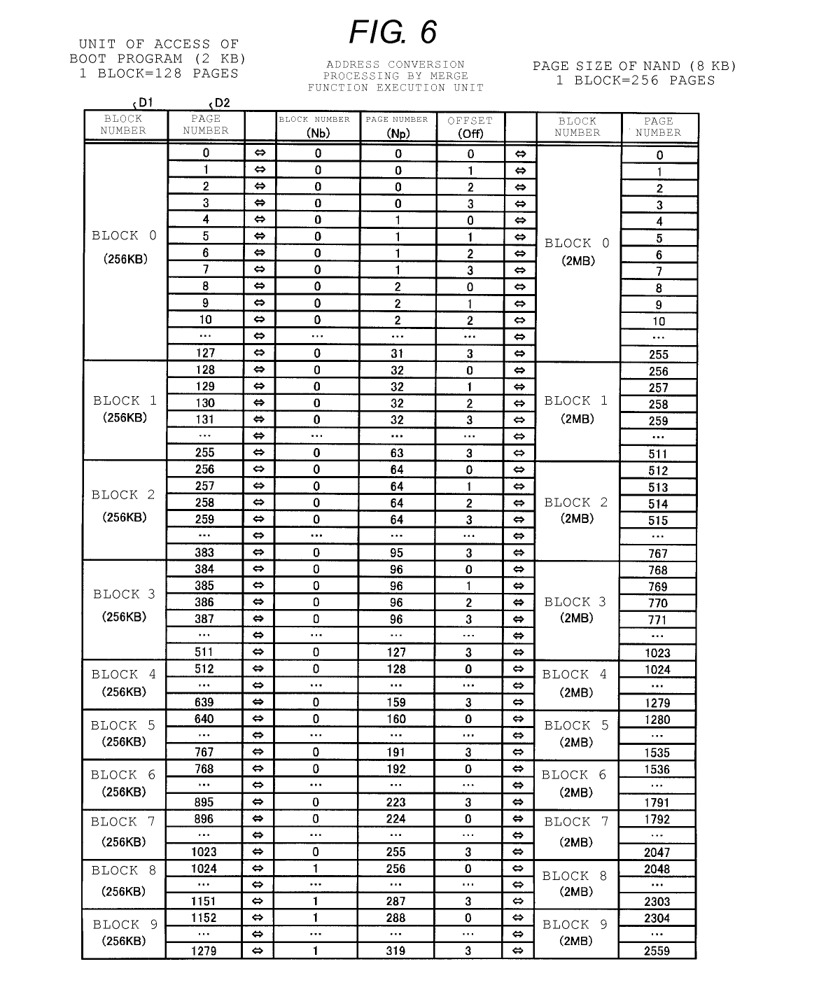

FIG. 6 illustrates address conversion processing which is performed by a merge function execution unit 24 when reading out and writing data. In FIG. 6, an access unit of the boot program BP, and the number of pages in the block which is recognized by the boot program BP are denoted in the left column. The access unit of the boot program BP is a page size which is recognized by the boot program BP, and is 2 KB in this example. In addition, the boot program BP recognizes that one block is configured with 128 pages. In FIG. 6, a page size of the NAND 10, and the number of pages in the block of the NAND 10 are denoted in the right column. In this example, the page size of the NAND 10 is 8 KB, and one block of the NAND 10 is configured with 256 pages.

The middle column in FIG. 6 denotes address conversion processing which is performed by the merge function execution unit 24. The address conversion processing can be applied to both the read processing and write processing, and the following address conversion is performed. Address designating the boot program BP is performed using consecutive page numbers as illustrated in column D2 in FIG. 6, without using a block number and a page number in the block. The block number which is denoted in column D1 in FIG. 6 is denoted for convenience only, and is not used when designating an address.

Here, a quotient by which a page size of the NAND 10 (8 KB) is divided by the page size which is registered in the page size identification information (2 KB) is referred to as a page size ratio R (=4). A quotient by which the page number designated by the host 1 is divided by the page size ratio R is the page number Np of the NAND 10, and the remainder becomes page offset Off. In addition, a quotient by which a page number Np is divided by the number of pages PP (=256) of one block of the NAND 10 becomes a block number Nb of the NAND 10.

For example, the page number 0 designated by the host 1 is converted into an address of a block number 0, a page number 0, and offset 0, the page number 1 designated by the host 1 is converted into an address of a block number 0, a page number 0, and offset 1, the page number 2 designated by the host 1 is converted into an address of a block number 0, a page number 0, and offset 2, and the page number 3 designated by the host 1 is converted into an address of a block number 0, a page number 0, and offset 3.

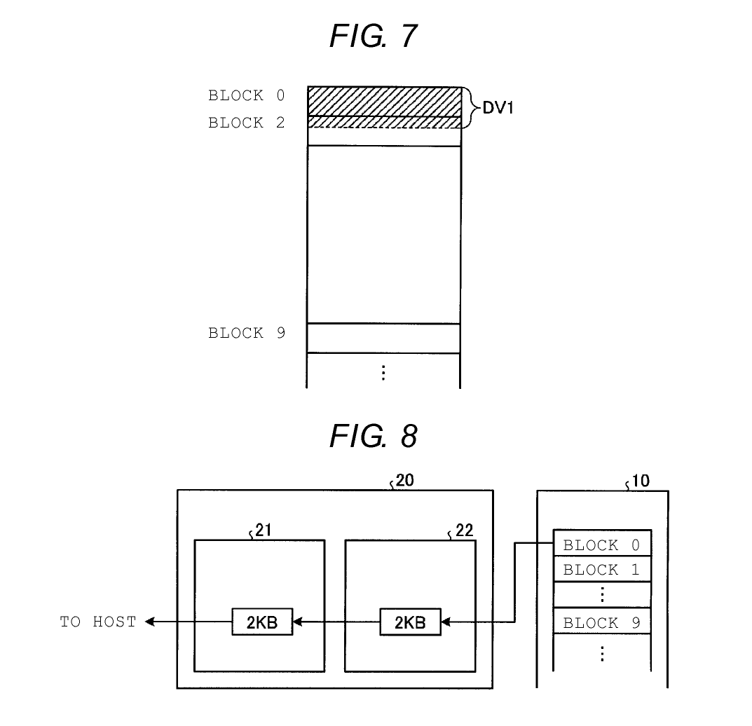

According to the address conversion, as illustrated in FIG. 7, a data storage region of 1280 pages in units of 2 KB pages designated by the host 1 corresponds to the first part of the blocks 0 to 9 of the NAND 10 (more specifically, from page 0 of block 0 to page 63 of block 1). In other words, the device driver DV1 is stored in the first part of the blocks 0 to 9 of the NAND 10 through packing. In the previous readout processing on the blocks 0 to 9 which is described in step S150 in FIG. 5, the address conversion which is illustrated in FIG. 6 is performed, and the device driver DV1 is read out from the region between the page 0 of the block 0 and the page 63 of the block 1 in the NAND 10, and is transmitted to the host 1.

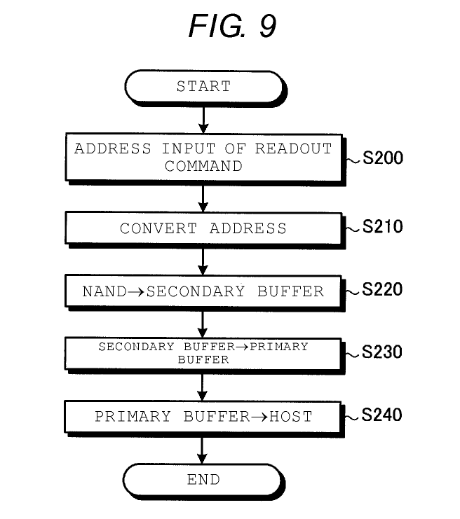

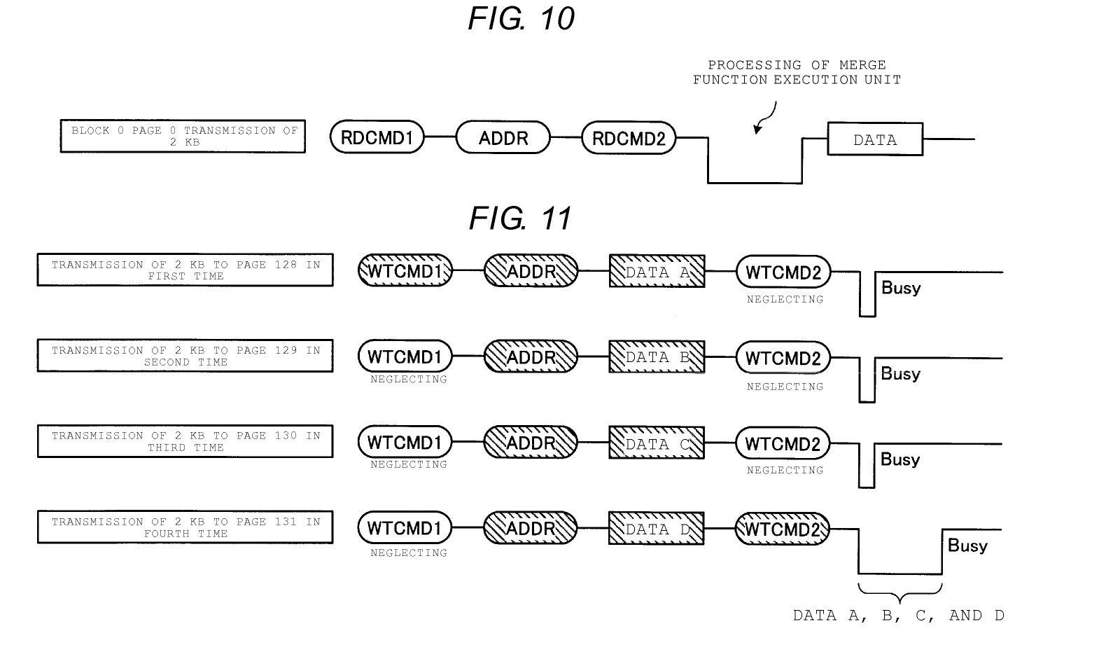

FIG. 8 illustrates readout processing of the memory system 100 in units of 2 KB. FIG. 9 is a diagram which illustrates readout processing order of the memory system 100. FIG. 10 is a time chart which illustrates readout processing of the memory system 100. The device driver DV1 of the host 1 sets a readout command, and a readout address in the register of the peripheral register group 33 (step S200). The merge function execution unit 24 converts a readout address which is input from the host 1 into a physical address of the NAND 10 using the address conversion processing which is illustrated in FIG. 6 when detecting that a first read command RDCDM1, an address ADDR, and a second read command RDCDM2 which are illustrated in FIG. 10 are received from the host 1 (step S210). As illustrated in FIG. 8, the merge function execution unit 24 reads out data of 2 KB from the NAND 10 using the converted address, and stores the read out data of 2 KB in the secondary buffer 22 (step S220). In addition, as illustrated in FIG. 8, the merge function execution unit 24 transmits the data of 2 KB which is stored in the secondary buffer 22 to the primary buffer 21 (step S230). In addition, as illustrated in FIG. 8, the merge function execution unit 24 transmits the data of 2 KB which is stored in the primary buffer 21 to the host 1 (step S240).

In addition, when a column readout sequence of the NAND 10 is used, it is also possible to read out data from the NAND 10 in a unit of byte by performing a column access in the unit of byte from the host 1.

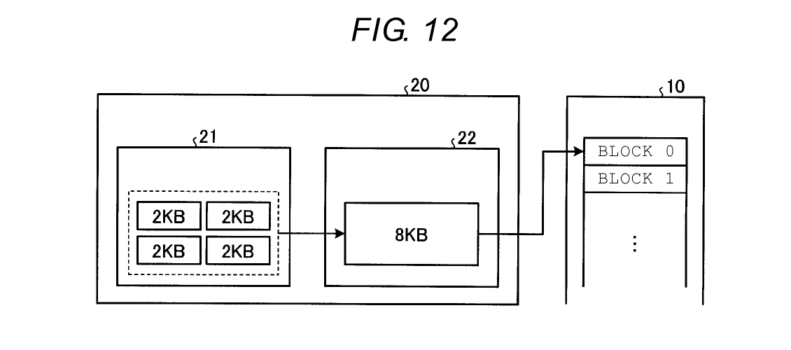

FIG. 11 illustrates a time chart when there is a request for normal write in a unit of 2 KB from the host 1. FIG. 12 is a diagram which illustrates normal write processing. The following write processing is performed when a manufacturer of the host system, or a manufacturer of the chip set changes and resets the device driver DV1.

In the memory system 100, write is performed in a page size unit (8 KB) of the NAND 10. On the other hand, write data from the host 1 is a unit of 2 KB. For this reason, as illustrated in FIG. 12, the merge function execution unit 24 buffers four data items of 2 KB in the primary buffer 21, merges the four data items which are buffered according to the address conversion rule which is illustrated in FIG. 6, buffers data of 8 KB after the merging in the secondary buffer 22, and writes the data of 8 KB which is buffered in the secondary buffer 22 in a predetermined block of the NAND 10 which is calculated according to the address conversion rule illustrated in FIG. 6.

As illustrated in FIG. 11, it is assumed that there is a request to write 2 KB in the page number 128 the first time, a request to write 2 KB in the page number 129 the second time, a request to write 2 KB in the page number 130 in the third time, and a request to write 2 KB in the page number 131 the fourth time from the host 1.

In the first data write from the host 1, the device driver DV1 of the host 1 sequentially sets a first write command WTCMD1, a write address ADDR, write data A, and a second write command WTCMD2 in the register of the peripheral register group 33. When detecting that the first write command WTCMD1, the write address ADDR (page number), and the write data A are received from the host 1, the merge function execution unit 24 transmits the data A to the primary buffer 21 from the register of the peripheral register group 33 through the I/O bus 5. In addition, the merge function execution unit converts the write address which is input from the host 1 into a merge address which is formed of the block number Nb, the page number Np, and the offset Off using the address conversion processing which is illustrated in FIG. 6. In addition, in the first write, the memory controller 30 ignores the second write command WTCMD2. Since the data is not written in the NAND 10 only by being buffered in the primary buffer 21, an assertion period of a busy signal Busy which is answered to the host 1 from the memory system 100 is short.

In the second data write from the host 1, the device driver DV1 of the host 1 sequentially sets the first write command WTCMD1, the write address ADDR, the write data B, the second write command WTCMD2 in the register of the peripheral register group 33. When detecting that the first write command WTCMD1, the write address ADDR, and the write data B are received from the host 1, the merge function execution unit 24 determines whether or not the write address ADDR is an address to be written on the same page as that of the write address ADDR (page number) which is input only at the time of the first data write. Processing when it is not the address to be written on the same page will be described later. In the example in FIG. 11, the addresses ADDR (page number) are successive in the second write, the third write, and the fourth write, and these addresses are addresses which will be written on the same page of the NAND 10. The merge function execution unit 24 transmits the write data B to the primary buffer 21 from the register of the peripheral register group 33 through the I/O bus 5. In addition, the merge function execution unit converts the write address which is input from the host 1 into a merge address which is formed of the block number Nb, the page number Np, and the offset Off using the address conversion processing which is illustrated in FIG. 6. In addition, in the second write, the memory controller 30 ignores the first write command WTCMD1, and the second write command WTCMD2. Similarly to the previous time, an assertion period of the busy signal Busy is short.

In the third data write from the host 1, the device driver DV1 of the host 1 sequentially sets the first write command WTCMD1, the write address ADDR, write data C, and the second write command WTCMD2 in the register of the peripheral register group 33. When detecting that the first write command WTCMD1, the write address ADDR, and the write data C are received from the host 1, the merge function execution unit 24 transmits the write data C to the primary buffer 21 from the register of the peripheral register group 33 through the I/O bus 5. In addition, the merge function execution unit converts the write address which is input from the host 1 into a merge address which is formed of the block number Nb, the page number Np, and the offset Off using the address conversion processing which is illustrated in FIG. 6. In addition, also in the third write, the memory controller 30 ignores the first write command WTCMD1, and the second write command WTCMD2. Similarly to the previous time, an assertion period of the busy signal Busy is short.

In the fourth data write from the host 1, the device driver DV1 of the host 1 sequentially sets the first write command WTCMD 1, the write address ADDR, write data D, and the second write command WTCMD 2 in the register of the peripheral register group 33. When detecting that the first write command WTCMD1, the write address ADDR, the write data D, and the second write command WTCMD2 are received from the host 1, the merge function execution unit 24 transmits the write data D to the primary buffer 21 from the register of the peripheral register group 33 through the I/O bus 5. In addition, the merge function execution unit converts the write address which is input from the host 1 into a merge address which is formed of the block number Nb, the page number Np, and the offset Off using the address conversion processing which is illustrated in FIG. 6. In addition, also in the fourth write, the memory controller 30 ignores the first write command WTCMD1.

In addition, when detecting a reception of the second write command WTCMD2, the merge function execution unit 24 merges four data items of 2 KB which are buffered in the primary buffer 21, in the order of offset Off, and buffers data of 8 KB after merging in the secondary buffer 22. In addition, the merge function execution unit 24 calculates an address on the NAND 10 in which the data of 8 KB after merging is to be written according to the address conversion rule which is illustrated in FIG. 6. In this case, the page number 32 of the block 0 is calculated. Accordingly, the merge function execution unit 24 writes merge data A, B, C, and D of 8 KB of which are buffered in the secondary buffer 22 on a page of the page number 32 of the block 0 of the NAND 10. When performing the fourth write from the host 1, an assertion period of the busy signal Busy is long, since write in the NAND 10 is performed in practice.

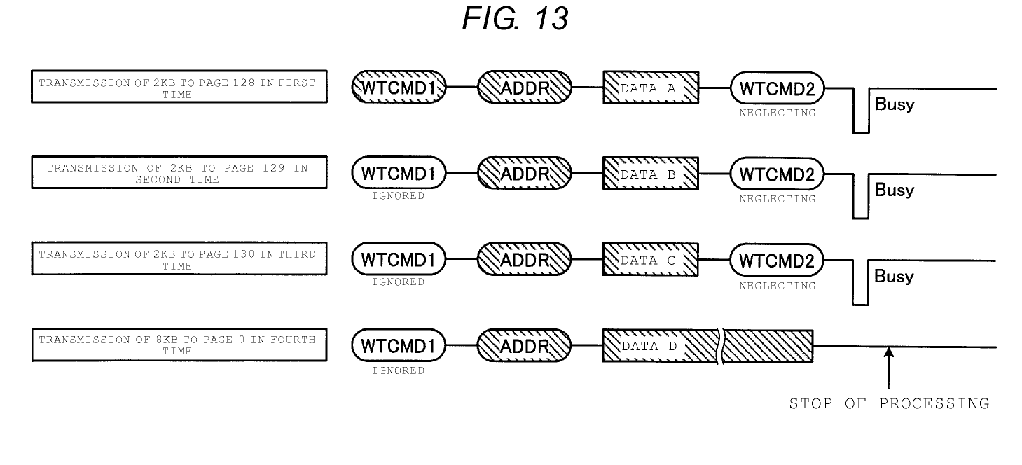

FIG. 13 illustrates write processing when there is a request for write of a data size which is different from registered contents of the page size identification information PI from the host 1. As illustrated in FIG. 13, it is assumed that there is a write request of 2 KB in the page number 128 in the first time, a write request of 2 KB in the page number 129 in the second time, a write request of 2 KB in the page number 130 in the third time, and a write request of 8 KB in the page number 0 in the fourth time from the host 1.

In a case of FIG. 13, since the write request from the host 1 matches the page size identification information in the first to third data write from the host 1, similar processing to the previous processing is performed. In the fourth write from the host 1, the device driver DV1 of the host 1 sequentially sets the first write command WTCMD1, the write address ADDR, the write data D, and the second write command WTCMD2 in the register of the peripheral register group 33. When detecting that the first write command WTCMD1, the write address ADDR (page number 0), the write data D are received from the host 1, the merge function execution unit 24 determines whether or not the address and the data size of the data D match the registered contents of the page size identification information PI. In this case, since the data size of the page number 0 which is included in the block 0 is registered as 2 KB in the page size identification information PI, the data size does not match the data D of 8 KB with the address of the page number 0.

Since the address and the data size of the data D do not match the registered contents of the page size identification information PI, the merge function execution unit 24 does not transmit the data D to the primary buffer 21. In addition, the memory controller 30 replies to the host 1 with error information which includes information denoting that the first to fourth data write of this time failed, and information denoting that the fourth data write does not match the page size identification information PI. Due to the error information, the host 1 can understand that the first to fourth data write have failed.

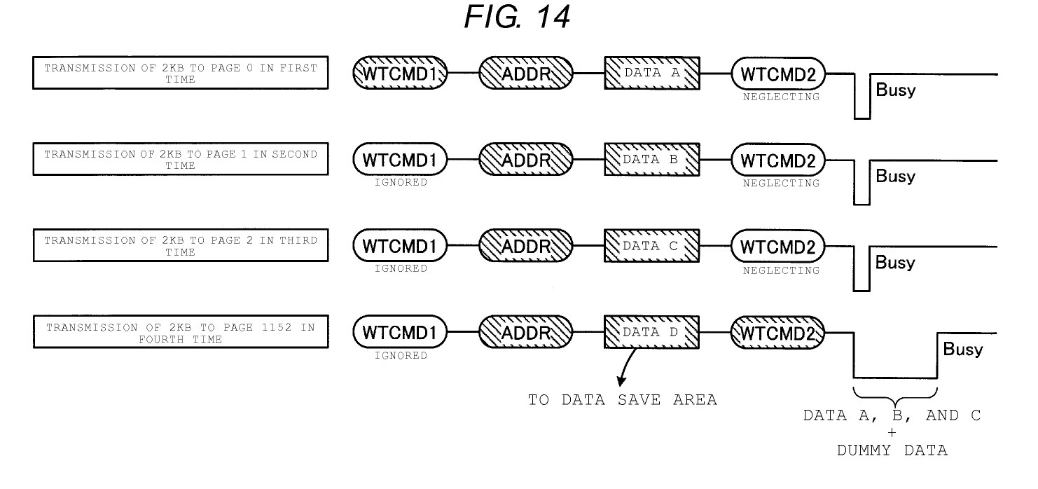

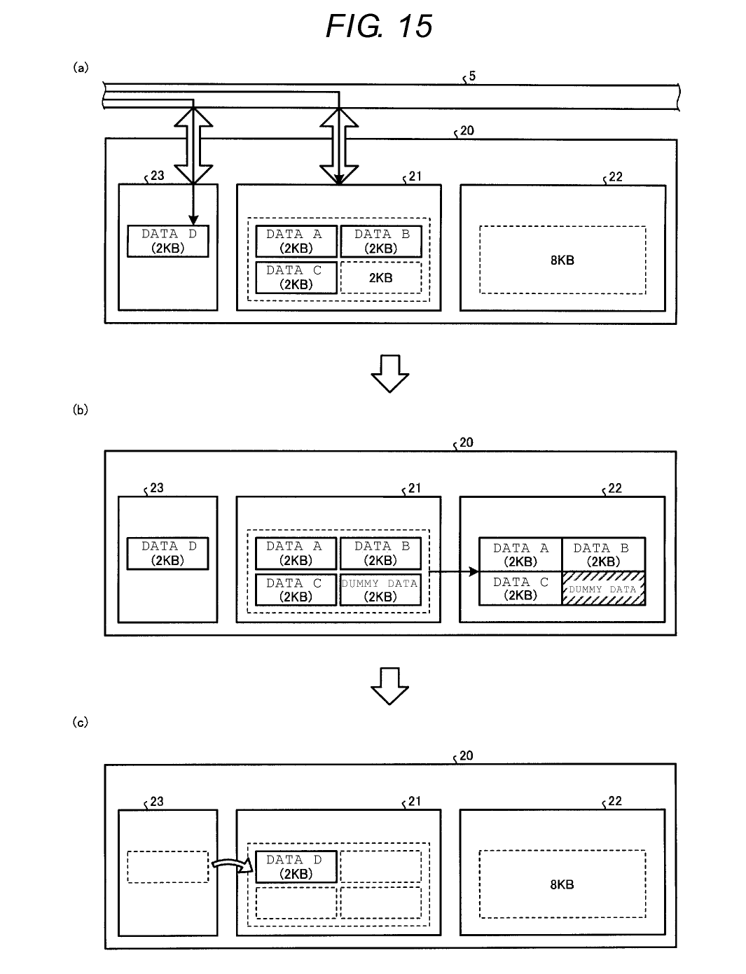

FIG. 14 is a time chart which illustrates write processing when there is a write request for data which will not be written on the same page by being merged with the first transmission data from the host 1. FIG. 15 is a diagram which illustrates write processing when there is a write request for data which will not be written on the same page by being merged with the first transmission data from the host 1. As illustrated in FIG. 14, it is assumed that there is a write request of 2 KB for the page number 0 the first time, a write request of 2 KB for the page number 1 the second time, a write request of 2 KB for the page number 2 the third time, and a write request of 2 KB for the page number 1152 (page 0 of block 9) the fourth time from the host 1.

In a case of FIG. 14, since the first to third data write requests from the host 1 are to be written on the same page of the NAND 10, similar processing to the previous processing is performed. Accordingly, as illustrated in (a) of FIG. 15, the first to third write data A, B, and C from the host 1 are sequentially buffered in the primary buffer 21. In the fourth data write from the host 1, the device driver DV1 of the host 1 sequentially sets the first write command WTCMD1, the write address ADDR, the write data D, and the second write command WTCMD2 in the register of the peripheral register group 33. When detecting that the first write command WTCMD1, the write address ADDR (page number 0), and the write data D are received from the host 1, the merge function execution unit 24 determines whether or not the address and the data size of the data D match the registered contents of the page size identification information PI. In this case, since the data size of the page number 0 which is included in the block 9 is registered as 2 KB in the page size identification information PI, the data size matches the data D of 2 KB with the address of the page number 1152.

In addition, the merge function execution unit 24 determines whether or not the data D is to be written on the same page by being merged with the first transmission data based on the address of the data D. In this case, according to the address conversion rule which is illustrated in FIG. 6, the data requesting the first data write is to be written on the page 0 of the block 0 of the NAND 10, and the data requesting the fourth data write is to be written on the page 31 of the block 0 (page 288). Accordingly, the merge function execution unit 24 determines that the data requesting the fourth data write is not to be written on the same page as that of the data requesting the first data write. The merge function execution unit 24 does not transmit the fourth write data D to the primary buffer 21, and transmits the data to the data save area 23 as illustrated in (a) of FIG. 15.

In addition, the merge function execution unit 24 converts the write addresses of the first to third data write requests which are input from the host 1 into a merge address which is formed of the block number Nb, the page number Np, and the offset Off using the address conversion processing which is illustrated in FIG. 6. In addition, as illustrated in (b) of FIG. 15, the merge function execution unit 24 merges three data items of A, B, and C of 2 KB which are buffered in the primary buffer 21 in order of the offset Off, causes the merged data of 6 KB to be data of 8 KB by adding dummy data thereto, and buffers the data of 8 KB in the secondary buffer 22. In addition, the merge function execution unit 24 calculates an address on the NAND 10 in which the merged data of 8 KB is to be written according to the address conversion rule which is illustrated in FIG. 6. In this case, the page number 0 of the block 0 is calculated. Accordingly, the merge function execution unit 24 writes the merge data of 8 KB (A+B+C+dummy data) which are buffered in the secondary buffer 22 on the page of the page number 0 of the block 0 of the NAND 10. Since the write in the NAND 10 is performed in practice, an assertion period of the busy signal Busy is long at the time of the fourth data write from the host 1. Thereafter, as illustrated in (c) of FIG. 15, the data D which is saved in the data save area 23 is transmitted to the primary buffer 21. The data D which is buffered in the primary buffer 21 is written in the NAND 10 through the secondary buffer 22 after becoming data of 8 KB by being combined with the write data from the host 1 or dummy data, according to contents of the write request from the host 1 thereafter.

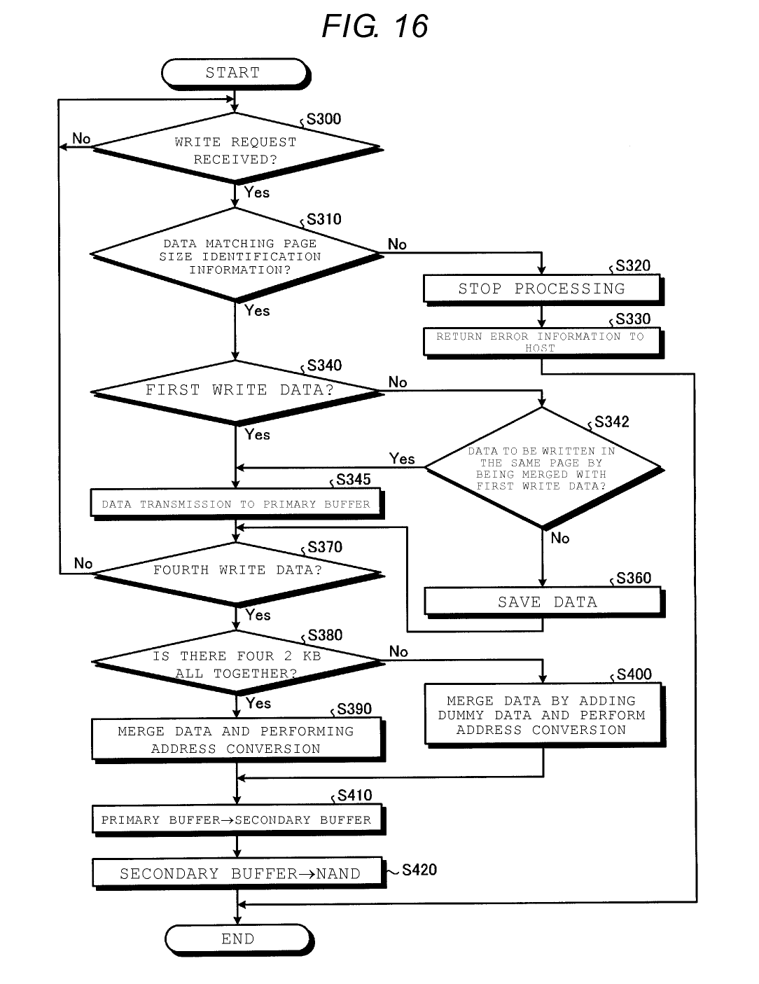

FIG. 16 is a flowchart which illustrates write processing order in the merge function execution unit 24 which is described in FIG. 11 to FIG. 15. In addition, in the write order, a page size as the unit of write of the NAND 10 is 8 KB, being four times of the unit of the write data (2 KB) in one command sequence from the host 1, and write in the NAND 10 of once in four command sequences is performed. For this reason, when a page size of the NAND 10 is 16 KB, write in the NAND 10 of once in eight command sequences is performed.

When receiving the write request from the host 1 (step S300), the merge function execution unit 24 determines whether or not a write address and a data size which are designated by the write request match contents of the page size identification information PI which is stored in the page size identification information storage unit 40 (step S310). In addition, as the example which is illustrated in FIG. 13, when the write address and the data size which are designated by the write request do not match the contents of the page size identification information PI, the merge function execution unit 24 stops the processing at this point (step S320), and transmits error information to the host 1 (step S330).

When the determination in step S310 is Yes, the merge function execution unit 24 determines whether or not the data write is the first write request, thereafter (step S340). When the determination in step S340 is Yes, the merge function execution unit 24 transmits the write data which is set in the register of the peripheral register group 33 to the primary buffer 21 (step S345). When the determination in step S340 is No, that is, when the write request of this time is write requests of second to fourth times, the merge function execution unit 24 determines whether or not write data which is designated by the write request of this time is data which will be written on the same page as that of the write data which is designated by the first write request (step S342). The merge function execution unit 24 executes determination processing in step S342 based on the write address which is designated by the first write request, the write address which is designated by the write request of this time, and the address conversion rule which is illustrated in FIG. 6.

When the determination processing in step S342 is Yes, the merge function execution unit 24 transmits the write data which is designated by the write request of this time to the primary buffer 21 from the register of the peripheral register group 33 (step S345). On the other hand, when the determination processing in step S342 is No, as described using FIGS. 14, and 15, the merge function execution unit 24 transmits the write data which is designated by the write request of this time to the data save area 23 from the register of the peripheral register group 33 (step S360).

In step s370, whether or not the write request of this time is the request of the fourth time is determined, and when the determination result is No, the process returns to step S300, and the above described processes in steps S310 to S370 are repeated until the determination result in step S370 becomes Yes.

When the write request of this time is determined to be the request of the fourth time in step S370, the merge function execution unit 24 determines whether or not four data items of 2 KB are buffered in the primary buffer 21 (step S380). When the four data items of 2 KB are buffered in the primary buffer 21, the merge function execution unit 24 merges the four data items of 2 KB which are in the primary buffer 21 in order of the offset Off (step S390), and buffers the merged data of 8 KB in the secondary buffer 22 (step S410). In addition, the merge function execution unit 24 calculates an address on the NAND 10 in which the merged data of 8 KB is to be written according to the address conversion rule which is illustrated in FIG. 6, and writes the merge data of 8 KB which is buffered in the secondary buffer 22 on the page of the NAND 10 according to the calculated address (step S420).

When only data items of one to less than four are buffered in the primary buffer 21 in step S380, the merge function execution unit 24 creates data of 8 KB by filling up the shortage with dummy data (step S400). For example, when only two data items including the first write data and the third write data are buffered in the primary buffer 21, merge processing of the write data and the dummy data is performed with reference to the address conversion rule which is illustrated in FIG. 6 so that the dummy data is arranged at portions corresponding to the second write data and the fourth write data. In the examples which are illustrated in FIG. 15, the dummy data is arranged at the portion corresponding to the fourth write data since only the data of the fourth write is insufficient. The merge function execution unit 24 buffers the merge data of 8 KB which is filled up using the dummy data in the secondary buffer 22 (step S410). In addition, the merge function execution unit 24 calculates an address on the NAND 10 in which the merged data of 8 KB is to be written according to the address conversion rule which is illustrated in FIG. 6, and writes the merge data of 8 KB which is buffered in the secondary buffer 22 according to the calculated address on the page of the NAND (step S420).

In this manner, according to the embodiment, it is possible to set a page size for apart of blocks which is stored in the device driver DV1 in the page size identification information from the outside. For this reason, a manufacturer of a host system, or a manufacturer of a chip set is able to change and reset a page size of such part of blocks so that the part of blocks which stores the device driver DV1 can be read out by a boot program on the host system side, and due to this, at the time of recognition processing of a memory system using the boot program, it is possible to prevent the processing from being stopped, and to ensure that the host system is started.

In addition, according to the embodiment, since a data merging function in which a plurality of write data items from the host are merged, and the merged plurality of data items are written in a page of the NAND 10, and an address conversion function are included, it is possible to perform a changing operation of the device driver DV1 by a manufacturer of the host system, or a manufacturer of the chip set, even when a page size of the NAND 10 is n times (n is natural number which is equal to or greater than 2) of a data size to which the host system side accesses the part of blocks in which the device driver DV1 is stored.

In addition, according to the embodiment, when a write to a block in which the device driver DV1 is stored is performed, it is determined whether or not the write data page size matches registered contents of the page size identification information, and error information is transmitted to the host system in the case of no matching, and accordingly, when it is not possible for the memory system side to receive the data size which is designated on the host system 1 side, it is possible to detect abnormality on the host system side, and to reduce changing operations of the device driver DV1.

In addition, according to the embodiment, when a subsequent write to a block in which the device driver DV1 is stored is performed, it is determined whether or not the write data is written to the same page as the earlier write so that it can be merged with the earlier write data, and when the data cannot be written to the same page, the write data is saved in the data save area, and when data is insufficient with respect to a page size of the NAND 10 due to the write data being saved into the data save area, dummy data is added to make up for the shortage.

In addition, according to the embodiment, write data of the host 1 is received in the register of the peripheral register group 33 once, and the write data which is set in the register of the peripheral register group 33 is transmitted to the primary buffer 21 by the memory controller 30; however, it is also possible for the memory controller 30 to directly move the data which is output on the I/O bus 5 by the host 1 into the primary buffer 21.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile memory which is configured in units of erasable blocks each having a first size and units of pages each having a second size within each block;
a page size identification information storage unit configured to store a third size that is smaller than the second size; and
a control unit configured to convert a first address designated in a command by the memory system into a second address,
wherein the first address specifies a page number of pages having the third size and the second address specifies a page number of pages having the second size.

2. The system according to claim 1,
wherein the second address further specifies a block number of blocks having the first size and an offset within a page targeted by the second address.

3. The system according to claim 1,
wherein the third size is 1/n (n is natural number which is equal to or greater than 2) of the second size.

4. The system according to claim 3, wherein the command is a read command.

5. The system according to claim 3, wherein the command is a write command.

6. The system according to claim 5, wherein the control unit is configured to buffer data associated with multiple write commands and store the buffered data associated with multiple write commands into a single page of the non-volatile memory.

7. The system according to claim 6, wherein the multiple write commands include n write commands received in consecutive order.

8. The system according to claim 7, wherein the multiple write command includes less than n write commands received in consecutive order and the control unit is configured store into the single page dummy data in addition to the buffered data.

9. The system according to claim 1,
wherein the page size identification information storage unit is configured to store the third size and additional data identifying blocks of the non-volatile memory that are to be addressed using the third size.

10. The system according to claim 9,
wherein the non-volatile memory stores a device driver for the memory system in the blocks of the non-volatile memory identified by the additional data.

11. An information processing device comprising:
a host system including a processor which executes a boot program; and
a memory system including a non-volatile memory which is configured in units of erasable blocks each having a first size and units of pages each having a second size within each block, and a page size identification information storage unit in which a third size that is smaller than the second size and meets a condition specified by the boot program is stored.

12. The device according to claim 11,
wherein the page size identification information storage unit stores the third size and additional data identifying blocks of the non-volatile memory that are to be addressed using the third size.

13. The device according to claim 12,
wherein the non-volatile memory stores a device driver for the memory system in the blocks of the non-volatile memory identified by the additional data.

14. The device according to claim 13,
wherein the host system includes system memory into which the device driver is loaded by accessing one or more of the blocks of the non-volatile memory identified by the additional data upon executing the boot program.

15. The device according to claim 11,
wherein the memory system further includes a control unit configured to convert a first address designated in a command received from the host system into a second address, the first address specifying a page number of pages having the third size and the second address specifying a page number of pages having the second size.

16. The device according to claim 15,
wherein the second address further specifies a block number of blocks having the first size and an offset within a page targeted by the second address.

17. A method of processing a command to read data stored in a non-volatile memory which is configured in units of erasable blocks each having a first size and units of pages each having a second size within each block, comprising:
converting a first address designated in the command unit into a second address, wherein the first address specifies a page number of pages having a third size that is smaller than the second size and the second address specifies a block number of blocks having the first size, a page number of pages having the second size, and an offset within a page corresponding to the page number;
reading data from the page of the non-volatile memory corresponding to the page number; and
returning data located at the offset within the page of the non-volatile memory corresponding to the page number.

18. The method according to claim 17,
wherein the returned data has a data length equal to the third size.

19. The method according to claim 18,
wherein the third size is 1/n (n is natural number which is equal to or greater than 2) of the second size.

20. The method according to claim 17,
wherein the command to read data is issued upon execution of a boot program in a host system that is connected to a memory system including the non-volatile memory, and the returned data is a device driver for the memory system that is to be loaded into system memory of the host system.
